(19) United States
(12) Patent Application Publication
(10) Pub. No.: US 2016/0216883 A1
(43) Pub. Date: Jul. 28, 2016

(54) DEVICE AND METHOD FOR RELAYING INFORMATION BETWEEN PAPER FORMAT AND A DATA FORMAT THAT CAN BE MANIPULATED AND FURTHER TRANSMITTED

(71) Applicant: Fran Sherman, Maryland Heights, MO (US)

(72) Inventor: Fran Sherman, Maryland Heights, MO (US)

(21) Appl. No.: 14/283,304

(22) Filed: May 21, 2014

(51) Int. Cl. G06F 3/0488; G06F 3/041; G06K 9/00

(52) U.S. Cl. CPC G06F 3/04883; G06K 9/00852; G06F 3/041

(57) ABSTRACT

There is provided an information relay device suitable for providing a user with the convenience of writing with a traditional or standard writing implement such as an ink pen or a pencil on a sheet of paper while providing a capability to store, display, and update the scripted information. The information relay device includes a platform and a feedback station that has a plurality of repositories.

### BACKGROUND OF THE INVENTION

The present invention relates to a device and a method for relaying information between a paper format and a data format that can be manipulated and further transmitted. Devices have been suggested that have an electronic digitizing writing feature which is compatible with a person using a conventional pen or pencil to makes notes on a piece of paper. The electronic digitizing writing feature then records selected information so that, in effect, the person has what can be described as an electronic copy of the information that has been scribed by the conventional pen or pencil on the piece of paper. U.S. Pat. No. 6,396,481 to Challa et al discloses a digitizing writing device that captures ink data on an ink capturing device while simultaneously capturing electronic pen stroke and transmitting the captured data with a built in wireless transceiver to an adjacent electronic image display surface. U.S. Pat. No. 5,631,741 to Matthews propose a touch sensitive area under a piece of paper which records an image of the writing as pixel positions that are stored in a memory array. The memory array operates in typical fashion in that information stored therein can be later read out to a computer. U.S. Pat. No. 5,631,741 to Matthews discloses the use of vector graphics to represent characters.

U.S. Pat. No. 5,629,499 to Flickinger et al discloses a writing board upon which information is written on paper while simultaneously is recorded digitally such that users can retain both copies. The patent further discloses the use of a bar code reader on the writing board that scans in a bar code recorded on the writing paper so that the paper and digital copies can be linked for further document processing and storage. The approach disclosed in this patent requires the use of a customized pen. Another disadvantage of a customized pen is that it might be uncomfortable or difficult to use in contrast to conventional pens or pencils. The need exists, therefore, for a convenient and stable arrangement that permits a person to use a conventional pen or pencil to makes notes on a piece of paper while permitting the person to retain some form of electronic copy of the information that has been scribed by the conventional pen or pencil on the piece of paper.

### SUMMARY OF THE INVENTION

The present invention solves the above-mentioned problems by providing an information relay device that permits hand scribed notes or other writings to be placed on a conventional piece of paper while automatically converting such notes or other writings to information stored on a device separate from the piece of paper, whereby such stored information can be re-accessed, updated, or supplemented via a wired or wireless network.

It is one object of the present invention to provide a new and improved information relay device that may be easily and efficiently manufactured.

It is a further object of the present invention to provide a new and improved information relay device that is convenient to deploy and to carry.

According to one aspect of the present invention, there is provided an information relay device including a feedback station, the feedback station having a plurality of repositories, and a platform disposable in a port mode with the feedback station via which selected markings placed on the platform are associated by the feedback station with discrete repositories and a deploy mode in which the selected markings will not be associated by the feedback station with repositories if these selected markings were to be placed on the platform.

According to further features of the one aspect of the present invention, the platform has a surface that can carry non-transient markings while the platform in its deployed mode and the platform and the feedback station are operatively couplable with one another in a manner in which a non-transient marking placed on the platform is associated with at least one of the repositories of the feedback station. Also, the feedback station is operably interconnectable with an information exchange medium that is not the platform with this operable interconnection being such one or both of the feedback station and the information exchange medium alters, deletes, or supplements information about a respective non-transient marking associated with a given repository of the feedback station as a function of the presence, absence, or content of the information about the respective non-transient marking associated with the given repository of the feedback station.

In accordance with a preferred feature of the information relay device, the platform includes a portion formed of paper fibers capable of carrying a non-transient marking and the feedback station includes a tray portion on which the paper fibers portion of the platform can be disposed and the feedback station is operable such that a marking placed on the paper fibers portion of the platform while the platform is disposed on the tray portion is readable by the feedback station to associate the marking with a respective repository of the feedback station. The platform in its paper mode can display a list format with designated areas to display items on a list or a calendar format with designated area to display event entries, reminders, or other calendar-associated markings.

The present invention is generally directed towards a convenient-to-carry and convenient-to-use information relay device. The principles of the present invention, however, are not limited to the particular configurations of information relay devices described herein. It will be understood that, in light of the present disclosure, the information relay device of the present invention, and its associated components and features, can be successfully used in connection with a variety of scenarios including as a stand-alone device and in combination with other information accessing devices. Additionally, to assist in the description of the information relay device of the present invention, words such as top, bottom, front, rear, right and left may be used to describe the accompanying figures, which may be but are not necessarily drawn to scale. It will be appreciated that the information relay device of the present invention can also be used as a stand-alone device or used in combination with other information processing or information handling arrangements.

### BRIEF DESCRIPTION OF THE DRAWINGS

Other features and advantages of the invention will become apparent to those skilled in the art upon review of the following detailed description, claims, and drawings.

FIG. 1a is a schematic elevational view of one embodiment of the information relay device of the present invention and showing a feedback station displaying a first template:

FIG. 1b is a schematic elevational view of the feedback station displaying a second template:

FIG. 2 is a schematic elevational view of one implementation possibility of the method of the present invention involving a list variation;

FIG. 3 is a schematic elevational view of the feedback station and several information exchange mediums;

FIG. 3a is an enlarged front elevational view of a screen window on the feedback station of the information relay device of the present invention shown in FIG. 3;

FIG. 4 is a schematic elevational view of one implementation possibility of the method of the present invention involving a calendar variation;

FIG. 5 is a perspective view of several exemplary variants of the platform of the information relay device of the present invention; and

FIG. 6 is a top perspective view of another variation of the information relay device of the present invention

### DETAILED DESCRIPTION OF AN EMBODIMENT

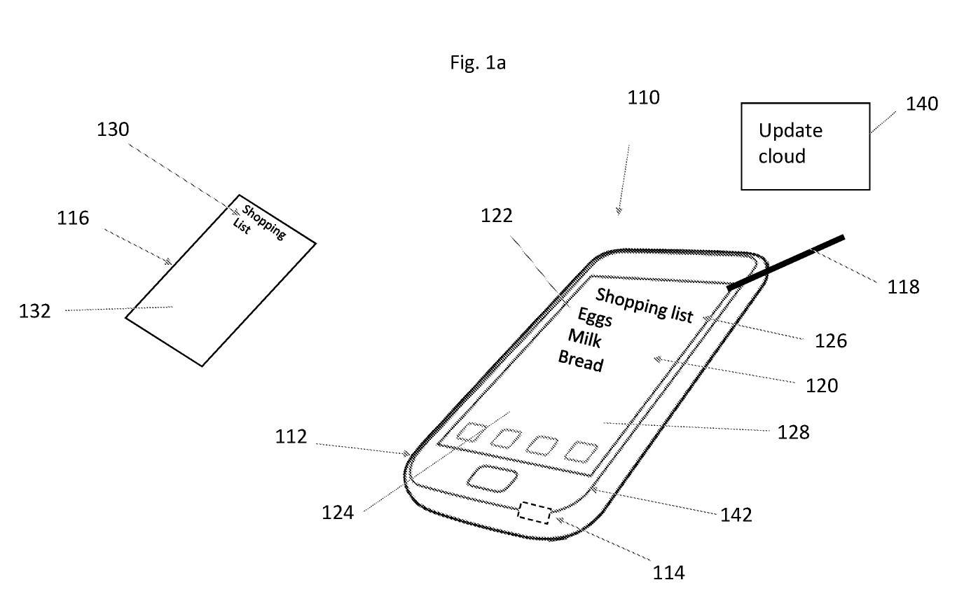

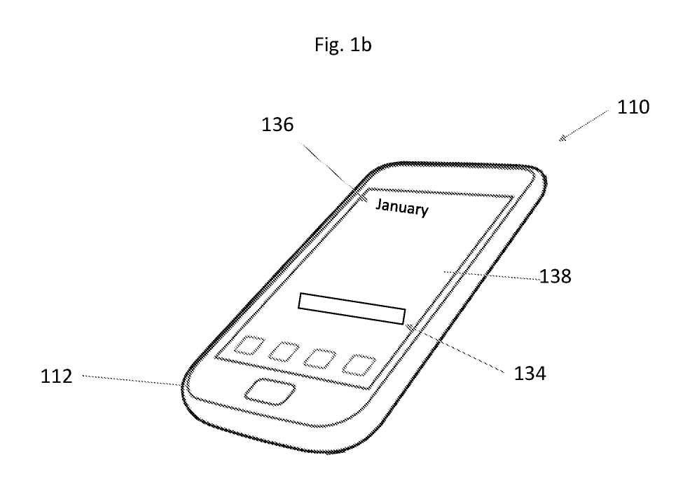

As seen in FIG. 1a, which is a schematic elevational view of one embodiment of the information relay device of the present invention, the information relay device is configured as an information relay device and is advantageously suitable for providing a user with the convenience of writing with a traditional or standard writing implement such as an ink pen or a pencil on a sheet of paper while providing a capability to store, display, and update the scripted information. The information relay device, which is generally designated as the information relay device 110, includes a feedback station 112 that has a plurality of repositories 114 and a platform 116. 110, includes a feedback station 112 that has a plurality of repositories 114 and a platform 116. The feedback station 112 is shown in an ergonomically favorable configuration whereby the feedback station can be comfortably held in the hand of a user and, to this end the feedback station 112 has an overall rectilinear shape approximately the size of a small computer tablet, for example.

The platform 116 is disposable in a port mode with the feedback station 112 via which selected markings placed on the platform are associated by the feedback station 112 with discrete ones of the repositories 114 and a deploy mode in which the selected markings will not be associated by the feedback station 112 with the repositories 114 if these selected markings were to be placed on the platform. The platform 116 is shown in a convenient, easy-to-carry configuration as a sheet of paper, it being understood that paper is defined herein as any material suitable for use with or as the platform 116 wherein such material comprises paper fibers, cardboard, or any other material operable to be marked on.

The platform 116 has a surface that can carry non-transient markings while the platform in its deployed mode. Thus, for example, with the platform 116 configured as a sheet of paper, markings can be made on the sheet of paper with a writing implement such as an ink pen, a dry marker, or a graphite-based implement such as a pencil. As will be described in more detail herein, the platform 116 and the feedback station 112 are operatively couplable with one another in a manner in which a non-transient marking placed on the platform 116 is associated with at least one of the repositories 114 of the feedback station 112, wherein a non-transient marking is to be understood herein as any discoloration of the paper via deposition of, for example, ink or pencil lead, any deformation of the paper producing a distinguishable marking, or otherwise any visually distinguishable trace placed on the paper that can serve the operation of the information relay device. A non-transient marking does not include a marking dependent upon the presence or absence of an electrical charge to remain visible nor does it include a marking projected as an image onto the paper that disappears once the projecting medium ceases projecting the image.

As shown in FIG. 1a, an exemplary writing implement in the form of an Ink pen 118 can deposit ink traces on the platform 116 via any known scripting techniques such as, for example, via a user holding the ink pen 118 in a hand and making non-alphabetic markings or moving the ink pen to produce, for example, cursive script or print script. The configuration of the platform 116 shown in FIG. 1 has a predetermined layout, as will be described in more detail herein, and the predetermined layout preferably assists a user in organizing the scripts in a selected manner, providing clarity between different groupings of script, and/or stimulating the thoughts or memory of a user with respect to selecting the nature and placement of the script on the platform 116. The predetermined layout of the platform 116 is coordinated with the layout presented by the feedback station 112 and, more specifically, this coordination involves configuring the feedback station with at least a first template and a second template and, as desired, further templates each different from one another.

As seen in FIG. 1a, the feedback station 112 includes a first template 120 displaying a first set of indicia 122 with the indicia 122 being at a predetermined orientation to each other. Solely for illustration purposes, the first template 120 is shown configured as a transient screen image on a screen 124 of the feedback station 112 and the indicia 122 of the first template 120 include the letters 126 forming the terms “Shopping List” and a plurality of straight line segments 128 equally spaced from one another in a longitudinal direction of the screen 124. It can be seen that the predetermined layout of the platform 116 is coordinated with the layout presented by the feedback station 112 in that the platform 116 also includes letters 130 forming the terms “Shopping List” and a plurality of straight line segments 132 equally spaced from one another in a longitudinal direction and, in fact, the position and size of letters forming the terms “Shopping List” and a plurality of straight line segments on the platform 116 and the feedback station 112 are identical so that the respective letters or straight line segments are coincident with one another when the platform 116 is disposed on the screen 124 of the feedback station 112 in the port mode of the platform 116.

The feedback station 112 includes a second template 134 and, solely for illustration purposes, the second template 134 is shown in FIG. 1b, which is a schematic elevational view of the feedback station displaying the second template, configured as a transient screen image on the screen 124 of the feedback station 112 in lieu of the first template 120. The second template 134 displays a second set of indicia 136 wherein the second set of indicia 136 are at least one of different than the indicia 122 in the first set of indicia 120 or at a different orientation to each other than the predetermined orientation of the indicia 122 of the first set of indicia 122 to each other.

In the example shown, the second set of indicia 136 of the second template 134 include the letters forming the calendar term “January”— which is different than the letters forming the terms “Shopping List” of the first template 120—and a plurality of straight line segments 138 each associated with a respective day of a month.

The feedback station 112 is operably interconnectable with an information exchange medium that is not the platform 116 and, as shown in FIG. 1a, the information exchange medium is shown configured as a computer network or a communication network accessible via a computer, telephonic device, or a processing element such as an electronic chip and designated as a cloud 140. However, it is noted that the information exchange medium can be any suitable device or arrangement capable of performing the information exchange steps involved with the operable interconnection of the feedback station 112 and the information exchange medium. This operable interconnection is such that one or both of the feedback station 112 and the information exchange medium alters, deletes, or supplements information about a respective non-transient marking associated with a given repository 114 of the feedback station 112 as a function of the presence, absence, or content of the information about the respective non-transient marking associated with the given repository 114 of the feedback station 112.

The repositories 114 of the feedback station 112 may be configured as transient data that can be generated and stored in an arrangement comprised of hardware, software, or a hybrid of hardware and software. For example, the information relay device can be provided with an ASIC electronic chip that is capable of processing information relating to each respective script or representation placed on the platform 116, dynamically assigning a transient association marker, and referencing the transient association marker for data handling and display purposes including, for example, generating an indicia 122 on the feedback station 112 that duplicates the respective script or representation placed on the platform 116 or providing information to the cloud 140 concerning the respective script or representation placed on the platform 116. It is also possible that the repositories 114 of the feedback station 112 can be hosted on the cloud 140 and the feedback station 112 merely comprises a display capability to display the scripts or representations as directed by the cloud 140.

The present invention contemplates that any suitable stroke tracking, stroke recordal, or stroke capture approach can be used to evaluate non-transient markings placed on the platform 116 by a user. A stroke is considered to be a movement of a user resulting in a non-transient marking and it can be understood that a stroke can be conceptualized as a series of x-y coordinate pairs generated as the tip of the writing implement is guided along the surface of the platform 116 by the user. Alphabetic representations, numerical representations, and graphic representations that are neither alphanumeric or numeric, can be understood as being composed of a series of strokes and from this understanding it can be conceived that data about these strokes, such as the sequence in which they are made or the vector (direction) or speed of the contact point of the writing implement as strokes are created can be used to distinguish and identify the individual strokes.

In addition to actively assessing in real time the movement characteristics of the writing implement to derive data about stroke formation, it is also possible to assess the alphabetic representations, numerical representations, and graphic representations after they have been placed on the platform 116 by deploying a number of known approaches such as Intelligent Character Recognition (ICR), Intelligent Word Recognition (IWR) and Optical Mark Recognition (OMR). Additionally, such approaches can be enhanced via the use of neural networks that recognize both printed script representations and cursive script representations.

The platform 116 may therefore be provided with, for example, a pressure sensitive digitizing surface operatively coupled with software and/or hardware. The pressure digitizing surface would therefore underlie the platform 116 when the platform 116 is disposed on the feedback station 112 in the port mode and the pressure digitizing surface can be responsive to the press contact thereon of the contact point of the writing implement as strokes are generated to create the alphabetic representations, numerical representations, and graphic representations

With respect to the software and/or hardware that can perform the stroke assessment, such software and hardware can be deployed to harvest stroke data and compare the observed or detected strokes and stroke groups or clusters to, for example, a catalog of strokes. Data about strokes can be uploaded via, for example, a wired connection or a wireless transmitter, to a further processing unit, which can be the cloud 140 or a personal computer, a personal digital assistant, a mobile telephonic device, or the like.

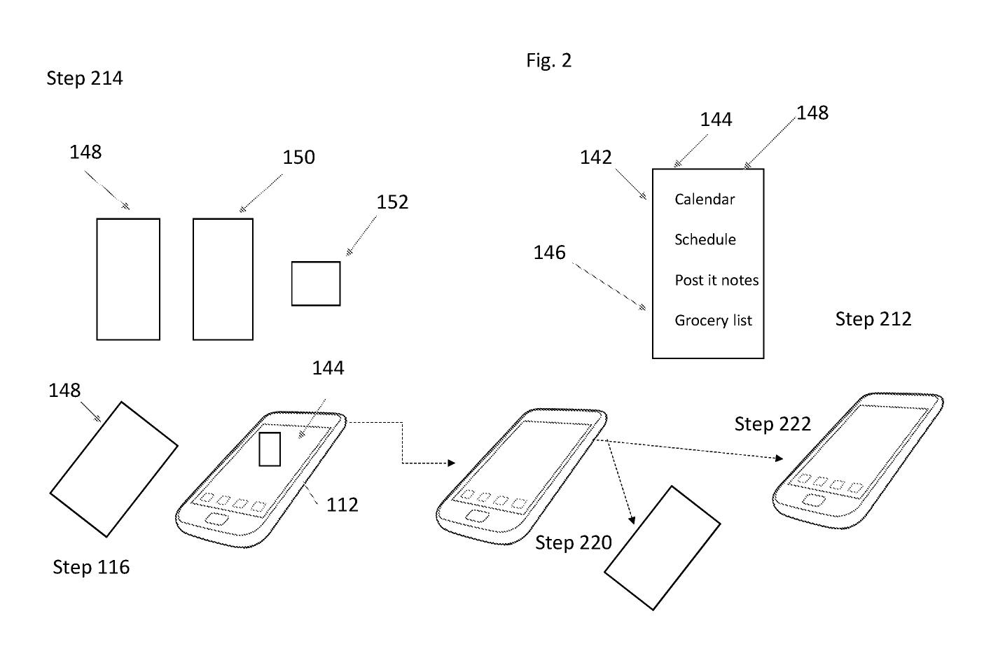

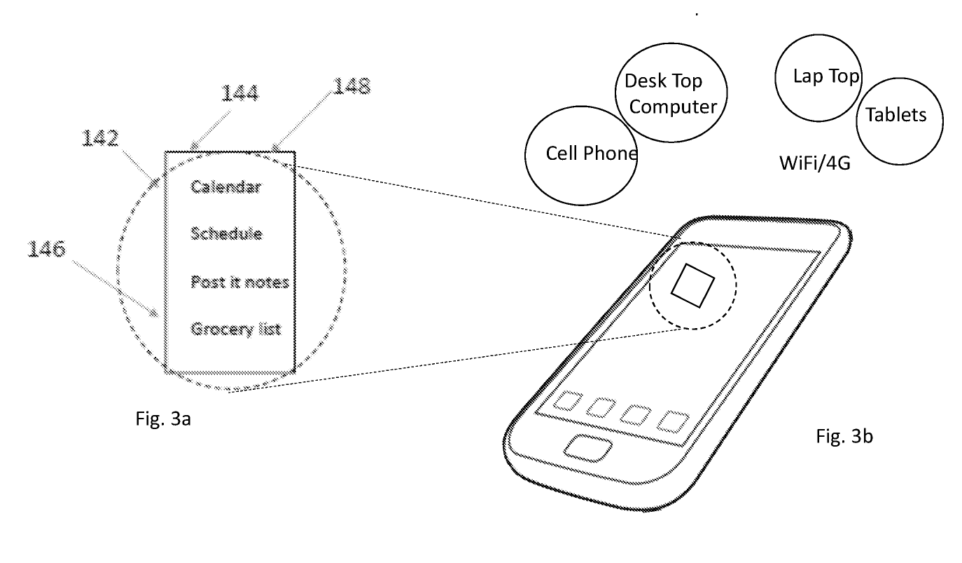

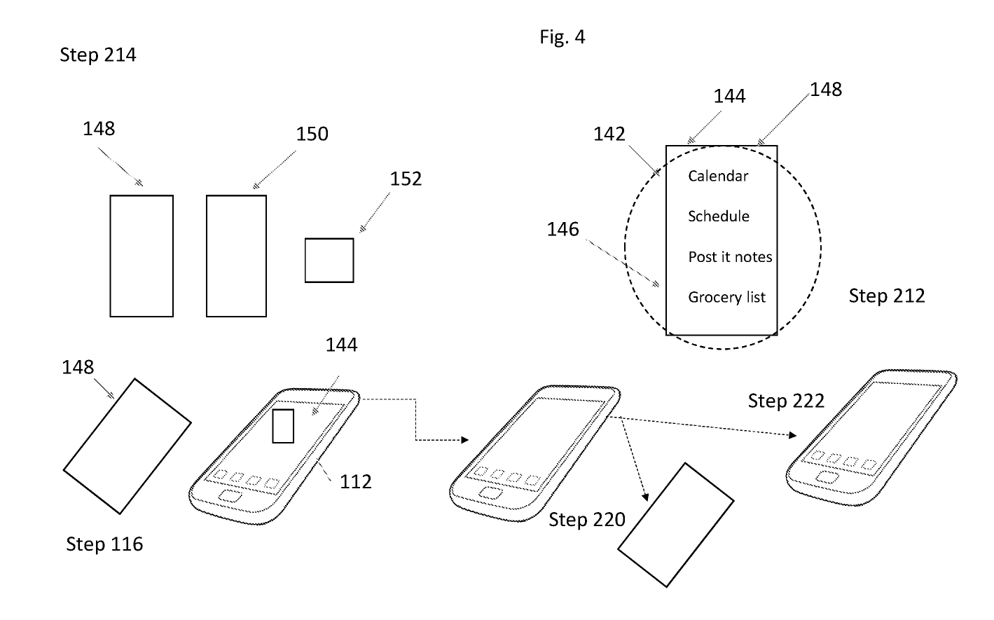

While one embodiment of the information relay device has been described with reference to FIG. 1a, it is to be understood that the present invention is also directed to a method for relaying information. To illustrate the method, reference is now had to FIG. 2, which is a schematic elevational view of one implementation possibility of the method of the present invention involving a list variation and FIG. 4, which is a schematic elevational view of one implementation possibility of the method of the present invention involving a calendar variation. With reference initially to FIG. 2, the list variation of the method, hereinafter referred to as the list variation 210, includes a step 212 of selecting an application. As seen in FIG. 3, which is a schematic elevational view of the feedback station and several information exchange mediums, it can be seen that data about strokes can be uploaded from the feedback station 112 via, for example, a wired connection or a wireless transmitter, to an information exchange medium that is in the form of a further processing unit, which can be the cloud 140 or a personal computer, a personal digital assistant, a mobile telephonic device, or the like. As seen in FIG. 3a, which is an enlarged front elevational view of a screen window on the feedback station of the information relay device of the present invention shown in FIG. 3, the feedback station 112 may be provided with a suitable display-capable tray 142 that can in the form, for example, of an liquid crystal display or tablet screen, and the feedback station 112 can be configured to display an application selection screen 144 in the event that a user desires to perform the steps of the list variation of the method of the present invention or, alternatively, choose another variation.

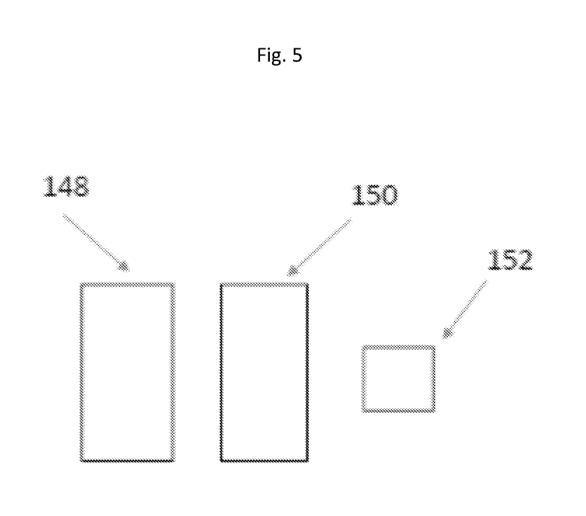

Continuing with the description of the list variation, a user may select an application entitled “Grocery” by touching a tab 146. Then, in a step 214, the user selects among several variants of the platform 116 to choose an appropriate variant of the platform 116 for use in connection with the application entitled “Grocery”. As seen in FIG. 5, which is a perspective view of several exemplary variants of the platform 116 each in the form of a sheet of imprinted paper, the several variants of the platform 116 can include a “Shopping List” variant 148, a “Calendar” variant 150, and a low tenacity adhesive variant 152. As seen in a step 216, the user has chosen the ‘Shopping list’ variant 148 for use with the “Grocery” application that had been selected on the feedback station 112 and the user disposes the “Shopping list” variant 148 into the tray 142 of the feedback station 112.

With the “Shopping list” variant 148 disposed in the tray 142 of the feedback station 112, the user then uses the ink pen 118, in a step 218, to print or write in cursive script on the “Shopping list” variant 148, which, as noted, is a sheet of imprinted paper. The feedback station 112 detects, senses, or otherwise makes note of the scripted letters that have been placed onto the “Shopping list” variant 148. Thereafter, in a step 220, the user removes the “Shopping list” variant 148 from the tray 142 of the feedback station 112. Since the “Shopping list” variant 148 is a sheet of Imprinted paper that now also bears a list of items that the user desires to purchase, the user can place the sheet of paper into a pocket or a purse, for example, or transfer the sheet of paper to another person who will attend to the shopping task.

In a step 222, the feedback station 112 performs an information exchange with an information exchange medium. Depending upon the configuration of the feedback station 112, the feedback station 112 may be configured to automatically exchange information with the cloud 140 in connection with the removal of the “Shopping list” variant 148 from the tray 142 of the feedback station 112 or, alternatively, the tray 142 may display, for example, a blinking screen tab that invites the user to press the tab and thereby initiate the information exchange. The feedback station 112 and the cloud 140 can be configured to cooperate such that a number of other transactions occur automatically or after user selection in addition to the information exchange between the feedback station 112 and the cloud 140 that relays information to the cloud 140 concerning the script that has been placed on the platform 116. For example, the cloud 140 may automatically or as a function of user prompting pass on appropriate notification to other devices operatively connected to the cloud 140 such as, for example, other devices accessed by the user such as a personal computer, a personal digital assistant, a mobile telephonic device, or the like. These other devices will then execute appropriate steps to update information or create information based upon the newly received information received by the cloud 140 concerning the script that has been placed on the platform 116. Moreover, the cooperation between the feedback station 112 and the cloud 140 can include having the cloud 140 provide updated, revised, or to-be-deleted information to the feedback station 112 that has been received from other devices of the user or that is later received from such devices. It can be understood that this will enable the user to visually compare the list composed on the “Shopping list” variant 148 with the now-updated list displayed on the tray 142 of the feedback station 112, whereupon the user can decide to amend the list on the “Shopping list” variant 148 by, for example, tracing a strike out line through an item on the list on the “Shopping list” variant 148 or printing or writing an additional item on the list on the “Shopping list” variant 148 to correspond with an item displayed on the tray 142 of the feedback station 112.

Enhancements can also be provided to further automate the user experience with the information relay device or to provide additional features. For example, to facilitate a comparison of the list composed on the “Shopping list” variant 148 with the now-updated list displayed on the tray 142 of the feedback station 112, the feedback station 112 can be configured to visually or aurally alert a user that deleted items or added items appear on now-updated list displayed on the tray 142 of the feedback station 112. The user can then decide to amend the list composed on the ‘Shopping list’ variant 148 or, alternatively, the user may choose to carry the feedback station 112 during a trip to a store so that the user can consult the now-updated list displayed on the tray 142 of the feedback station 112 in lieu of the list composed on the “Shopping list” variant 148. The feedback station 112 can be outfitted with features customary to portable or hand-held devices including, for example, a plug-in power source, a rechargeable battery, or other electrical power supplying features and including data transmission capabilities such as, for example, the capability to connect to a Wi-Fi communication network or to connect to a telephonic communication network such as a 4G telephone network.

Software and/or hardware that can perform the stroke assessment, such software and hardware can be deployed to harvest stroke data and compare the observed or detected strokes and stroke sets to, for example, a catalog of strokes. Data about strokes can be uploaded via, for example, a wired connection or a wireless transmitter, to a further processing unit, which can be the cloud 140 or a personal computer, a personal digital assistant, a mobile telephonic device, or the like.

Reference is now had to FIG. 4, which is a schematic elevational view of one implementation possibility of the method of the present invention involving a calendar variation. The calendar variation of the method, hereinafter referred to as the calendar variation 310, includes a step 312 of selecting an application. As seen in FIG. 3, the feedback station 112 displays the application selection screen 144 in the event that a user desires to perform the steps of the calendar variation of the method of the present invention and the user may select an application entitled “Calendar” by touching a tab 148. Then, in a step 314, the user selects among several variants of the platform 116 to choose an appropriate variant of the platform 116 for use in connection with the application entitled “Calendar”. As seen in FIG. 4, the user would choose the “Calendar” variant 150 during this step. As seen in a step 316, the user has chosen the “Calendar” variant 150 for use with the “Calendar” application that had been selected on the feedback station 112 and the user disposes the “Calendar” variant 150 into the tray 142 of the feedback station 112.

With the “Calendar” variant 150 disposed in the tray 142 of the feedback station 112, the user then uses the ink pen 118, in a step 318, to print or write in cursive script on the “Calendar” variant 150, which may be, for example, a sheet of Imprinted paper. The feedback station 112 detects, senses, or otherwise makes note of the scripted letters that have been placed onto the “Calendar” variant 150. Thereafter, in a step 320, the user removes the “Calendar” variant 150 from the tray 142 of the feedback station 112. The “Calendar” variant 150 is a sheet of imprinted paper that now also bears a calendar with event entries, reminders, or other calendar-associated markings.

Depending upon the configuration of the feedback station 112, the feedback station 112 may be configured to automatically exchange information with the cloud 140 in connection with the removal of the “Calendar” variant 150 from the tray 142 of the feedback station 112 or, alternatively, the tray 142 may display, for example, a blinking screen tab that invites the user to press the tab and thereby initiate the information exchange. Enhancements specific to the calendar variation of the method can include, for example, options allowing a user to of generate repeat entries of a calendared event on a weekly basis, a bi-weekly basis, or a monthly basis, for example.

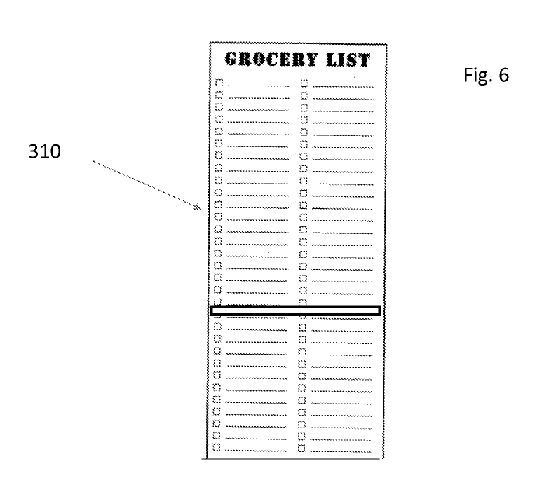

With reference to FIG. 6, which is a top perspective view of another variation of the information relay device of the present invention, a description will now be provided with regard to a further aspect of the present invention—namely, an information relay device is provided in a configuration in which the platform itself has an information repository capability and so the feedback station can be dispensed with. In this configuration, a platform 310 is disposable in a port mode via which selected markings placed on the platform are associated by with discrete repositories and a deploy mode in which the selected markings will not be associated with repositories if these selected markings were to be placed on the platform. Also, the platform 310 has a surface that can carry non-transient markings while the platform in its deployed mode, the platform having a first template displaying a first set of indicia with the indicia being at a predetermined orientation to each other and a second template displaying a second set of indicia wherein the second set of indicia are at least one of different than the indicia in the first set of indicia or at a different orientation to each other than the predetermined orientation of the indicia of the first set of indicia to each other. Further, the platform 310 is operably interconnectable with an information exchange medium with this operable interconnection being such one or both of the platform and the information exchange medium alters, deletes, or supplements information about a respective non-transient marking associated with a given repository of the platform as a function of the presence, absence, or content of the information about the respective non-transient marking associated with the given repository of the platform.

Although this invention has been disclosed and described in its preferred forms with a certain degree of particularity, it is to be realized that the optimum dimensional relationships for the parts of the invention, to include variations in size, materials, shape, form, function and manner of operation, assembly and use, are deemed readily apparent and obvious to one skilled in the art. Additionally, it is understood that the present disclosure of the preferred forms is only by way of example and that numerous changes in the details of operation and in the combination and arrangement of parts may be resorted to without departing from the spirit and scope of the invention as hereinafter claimed.

What is claimed is:

1. An information relay device comprising:
a feedback station, the feedback station having a plurality of repositories; and
a platform disposable in a port mode with the feedback station via which selected markings placed on the platform are associated by the feedback station with discrete repositories and a deploy mode in which the selected markings will not be associated by the feedback station with repositories if these selected markings were to be placed on the platform,
the platform having a surface that can carry non-transient markings while the platform in in its deployed mode, the platform and the feedback station being operatively couplable with one another in a manner in which a non-transient marking placed on the platform is associated with at least one of the repositories of the feedback station,
the feedback station having a first template displaying a first set of indicia with the indicia being at a predetermined orientation to each other and a second template displaying a second set of indicia wherein the second set of indicia are at least one of different than the indicia in the first set of indicia or at a different orientation to each other than the predetermined orientation of the indicia of the first set of indicia to each other,
the feedback station being operably interconnectable with an information exchange medium that is not the platform with this operable interconnection being such one or both of the feedback station and the information exchange medium alters, deletes, or supplements information about a respective non-transient marking associated with a given repository of the feedback station as a function of the presence, absence, or content of the information about the respective non-transient marking associated with the given repository of the feedback station.

2. The information relay device according to claim 1, wherein the platform includes a portion formed of paper fibers capable of carrying a non-transient marking and the feedback station includes a tray portion on which the paper fibers portion of the platform can be disposed and the feedback station is operable such that a marking placed on the paper fibers portion of the platform while the platform is disposed on the tray portion is readable by the feedback station to associate the marking with a respective repository of the feedback station.

3. The information relay device according to claim 2, wherein the platform includes a paper portion with selected areas in which a user can place non-transient markings, the first template of the feedback station is operable to determine selected information characteristic of such non-transient markings placed in the selected areas of the paper of the platform, and the feedback station is operable to display information corresponding to such non-transient markings in a display presentation that substantially tracks the appearance of the paper portion of the platform on which such non-transient markings have been placed.

4. The information relay device according to claim 3, wherein the information relay device is operable automatically or as a function of user prompting passes on appropriate notification to other devices operatively connected to the device including devices from the group of a personal computer, a personal digital assistant, and a mobile telephonic device, and these other devices execute appropriate steps to update information or create information based upon the newly received information received from the information exchange medium concerning the non-transient markings that have been placed on the platform.

5. The information relay device according to claim 4, wherein the information relay device has the capability to wirelessly connect to an information exchange medium that can include a Wi-Fi communication network or to connect to a telephonic communication network such as a 4G telephone network.

6. The information relay device according to claim 5, wherein the platform includes a display format with designated areas at which non-transient markings can be placed and the feedback station is operable to display updated information or newly created information based upon the newly received information received from the information exchange medium in a display format in which the updated information or newly created information is displayed in a format substantially tracking the display format of the platform.

7. The information relay device according to claim 6, wherein the platform includes a list format with designated areas to display items on a list.

8. The information relay device according to claim 6, wherein the platform includes a calendar format with designated area to display event entries, reminders, or other calendar-associated markings.

9. The information relay device according to claim 4, wherein the feedback station includes an application selection feature via which a user can select a display format to be displayed on the feedback station that corresponds to the display format of the platform.

10. An information relay device comprising:
a platform having an information repository capability, the platform being disposable in a port mode via which selected markings placed on the platform are associated by with discrete repositories and a deploy mode in which the selected markings will not be associated with repositories if these selected markings were to be placed on the platform, the platform having a surface that can carry non-transient markings while the platform in its deployed mode, the platform having a first template displaying a first set of indicia with the indicia being at a predetermined orientation to each other and a second template displaying a second set of indicia wherein the second set of indica are at least one of different than the indicia in the first set of indicia or at a different orientation to each other than the predetermined orientation of the indicia of the first set of indicia to each other, and
the platform being operably interconnectable with an information exchange medium with this operable interconnection being such one or both of the platform and the information exchange medium alters, deletes, or supplements information about a respective non-transient marking associated with a given repository of the platform as a function of the presence, absence, or content of the information about the respective non-transient marking associated with the given repository of the platform.

11. The information relay device according to claim 10, wherein the platform includes a paper portion with selected areas in which a user can place non-transient markings, the first template of the platform is operable to determine selected information characteristic of such non-transient markings placed in the selected areas of the paper of the platform, and the platform operable to display information corresponding to such non-transient markings in a display presentation that substantially tracks the appearance of the paper portion of the platform on which such non-transient markings have been placed.

12. The information relay device according to claim 11, wherein the information relay device is operable automatically or as a function of user prompting passes on appropriate notification to other devices operatively connected to the device including devices from the group of a personal computer, a personal digital assistant, and a mobile telephonic device, and these other devices execute appropriate steps to update information or create information based upon the newly received information received from the information exchange medium concerning the non-transient markings that have been placed on the platform.
